(19) United States
(12) Patent Application Publication
(10) Pub. No.: US 2021/0056490 A1
(43) Pub. Date: Feb. 25, 2021

(54) METHODS FOR REAL TIME MANAGEMENT OF ASSIGNMENT OF ELECTRONIC BILLS AND DEVICES THEREOF

(71) Applicant: Mitchell International, Inc., San Diego, CA (US)

(72) Inventors: Marius Dornean, Brea, CA (US); James Malkiewicz, Irvine, CA (US); Sirachat Thamrongsak, Irvine, CA (US)

(73) Assignee: Mitchell International, Inc., San Diego, CA (US)

(21) Appl. No.: 17/001,574

(22) Filed: Aug. 24, 2020

Related U.S. Application Data
(60) Provisional application No. 62/890,440, filed on Aug. 22, 2019.

(51) Int. Cl. G06Q 10/06; G06Q 40/00; G06Q 10/10; G06Q 40/08; G06N 20/00; G06N 5/04

(52) U.S. Cl. CPC G06Q 10/063112; G06Q 40/125; G06Q 10/1091; G06N 5/04; G06Q 10/063114; G06Q 40/08; G06N 20/00; G06Q 10/06398

(57) ABSTRACT

Systems and methods are provided for automating the process of managing automated real-time assignment of electronic bill based on at least a portion of the obtained electronic bills, productivity data, one or more characteristics of the bills, although other types of data or other information may be used to train the machine learning assignment algorithm. A machine learning assignment algorithm that determines assignment of each of a plurality of new and existing electronic bills to a plurality of auditor identifiers may be implemented. For example, the machine learning assignment algorithm may determine assignment based on current productivity data, current billing data, and current workload data.

### RELATED APPLICATIONS

This application claims the benefit of U.S. Provisional Application No. 68/890,440 filed on Aug. 22, 2019, the contents of which are incorporated herein by reference in its entirety.

### TECHNICAL FIELD

The present disclosure is generally related to systems and methods for determining electronic bill assignment, and more particularly, some embodiments relate to a systems and methods for implementing the same.

### BACKGROUND

As part of a claims management process in the insurance industry (e.g., workers compensation, auto casualty, and so on), bills for services rendered by providers must be submitted for review by an auditor prior to payment. Typically, as part of this claims management process, the auditors receive the bills though an assignment system. For example, a user (e.g., a team manager) manually reviews each new bill (e.g., medical bill) received and assigns the bill to one of the auditors of the audit team best suited for the task. When assigning the bill, the team manger uses their knowledge of auditor team's strengths. For example, team manager may rely on various criteria including the type of line of business (e.g., inpatient vs. hospital), jurisdiction, severity, claim amount, due date, and other such criteria.

The assignment of the bill to the auditor is done in an attempt to manage audit team's work load and reduce penalties associated with late payment. At best, this manually performed process has produced very inconsistent results and has often been inefficient and time consuming. In particular, because the assignment process relies on a human when reviewing the bill, the manual process often results in a bottleneck, as the throughput is limited by that user's ability to review and assign the bills correctly. Additionally, the manual process often results in a lag between the time when the bill is submitted and when the user reviews it. Furthermore, the accuracy of assignment may not be optimal and the bill may need to be re-assigned. That is, there are many assignment vectors that need to be considered when assigning the bill to an auditor; and each audiotor has strengths which may change over time. Accordingly, balancing these considerations may be difficult for a seasoned manager, let alone for someone who is less experienced. Furthermore, if the manager is absent, the team may have to rely on a substitute individual which may or may not know the team members' abilities.

### SUMMARY

In accordance with one or more embodiments, various features and functionality can be provided for analyzing and assigning electronic bills.

In some embodiments, a method implemented by a server computer may executing a machine learning assignment algorithm that determines assignment of each of a plurality of new and existing electronic bills to a plurality of auditor identifiers. For example, the machine learning assignment algorithm may determine assignment based on current productivity data, current billing data, and current workload data. In some embodiments, the current productivity data may include two or more metrics associated with each of plurality of auditor identifiers. Further, the current billing data may include one or more characteristics of each of the new and existing electronic bills. Finally, the current workload data comprising a quantity and one or more of the characteristics of the existing electronic bills associated with each of the auditor identifiers.

In some embodiments, the machine learning assignment algorithm may determine assignment based on at least historic productivity data comprising two or more metrics associated with each of the auditor identifiers, historic billing data comprising one or more characteristics of prior unaudited electronic claims; and historic monitored workload data comprising a quantity and one or more characteristics of the prior electronic bills associated with the auditor identifiers.

In some embodiments, the method may transmit the determined assignments of each of the electronic bills to one or more of the auditor identifiers.

In some embodiments, the method may receive an adjustment of at least one of the determined assignments of the electronic claims, wherein the training the machine learning assignment algorithm is further based on the received adjustment.

In some embodiments, the method may obtain at least a portion of the current productivity data and the current workload data associated with the auditor identifiers.

In some embodiments, the method may extract the one or more characteristics of each of the new and existing electronic bills to obtain the current billing data. For example, the two or more characteristics of the current productivity data may include amount of time data required to work on each of a plurality of types of electronic bills and overall work time data associated with the auditor identifiers. In some embodiments, the one or more characteristics of each of the new and existing electronic bills may include a plurality of types, a plurality of jurisdictions, charge amounts, bill age, a plurality of types of injuries, and/or a plurality of medical provider identifiers.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

FIG. 1 illustrates an example electronic bill assignment system, according to an implementation of the disclosure.

FIG. 2 illustrates a rule engine utilized by a prior art bill assignment system.

FIG. 3 illustrates example components of the electronic bill assignment system of FIG. 1, according to an implementation of the disclosure.

FIG. 4 illustrates example neural network algorithm, according to an implementation of the disclosure.

FIG. 5 illustrates processes for executing an assignment algorithm, according to an implementation of the disclosure.

FIG. 6 illustrates an example computing system that may be used in implementing various features of embodiments of the disclosed technology.

### DETAILED DESCRIPTION

Described herein are systems and methods for managing electronic bill assignments. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

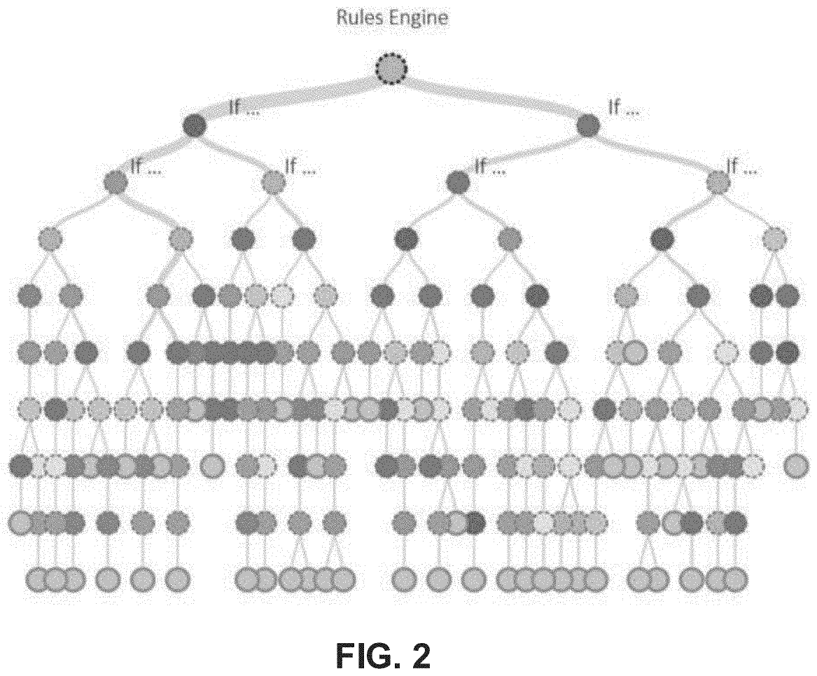

As alluded to above, manual assignment of newly received bills to a member of an audit team is inefficient and time consuming. Accordingly, attempts have been made to utilize technology to update and enhance this review and assignment process. In particular, currently available technology solutions attempted to optimize this manual review and assignment process by using a rules engine which utilizes assignment criteria based on a predefined set of rules. The use of rules engine has significant drawbacks as it scales due to the complexity, for example as illustrated in FIG. 2. In particular, a rule engine may include a complex hierarchy of logic (i.e., use of if/then operators) and may result from chaining together multiple assertions. The visual is meant to indicate how quickly a hierarchy of rules can get extremely complex. As a result, existing technological solutions have serious shortcomings with effectively and efficiently optimizing the management of assignment of electronic bills.

Embodiments of the disclosed technology provide a system and method for determining an optimal assignment for an electronic bill. In particular, by virtue using machine learning algorithms allows the system to automate majority of the judgments and decisions currently done by human expertise. Furthermore, the decisions produced by the present system, are more accurate than those associated with the human user. Accordingly, the present technology substantially improves the efficiency and consistency of this assignment process.

Other examples of this technology capture and group bill characteristics to make inference on bill difficulty and priority. This technology also captures auditors' productivity metrics to make inference on their expertise and competency. This technology then utilizes the historical data on these inferences to make real-time bill assignment without requiring manual intervention.

This technology optimizes in real time automated management of assignments of unaudited electronic bills. With this technology, there is a considerable increase in the efficiency of how unaudited electronic medical bills are being assigned to and managed by a team of bill auditors during a bill review process, leading to the reduction of penalties and fees associated with late payment. Accordingly, this technology automatically provides a recommended assignment and prioritization of electronic bills in an efficient, verifiable, and reproducible manner based on extracted characteristics, historical data and real time monitoring of efficiency. The functioning of the assignment analysis computing device is advantageously improved with this technology, which uses fewer resources, including memory and processor cycles, as compared to utilizing a rules engine to identify an optimal assignment and prioritization, for example.

Additional advantages of example of the technology include: improving processing efficiency; automation on a real time basis substantially reduces manual work and also prior technological automation attempts leading to productivity gain; productivity optimization; automation on a real time basis results in a more optimal work assignment for the team in comparison to manual work assignment; and scalability. Unlike automation based on a traditional rules engine, this technology is easier to set up and maintain. Further this technology provides assignment tailored to the individual user. Unlike automation based on a traditional rules engine, this technology utilizes individual user's data to make a decision to assign bills in a way that is tailored to the specific user.

### System

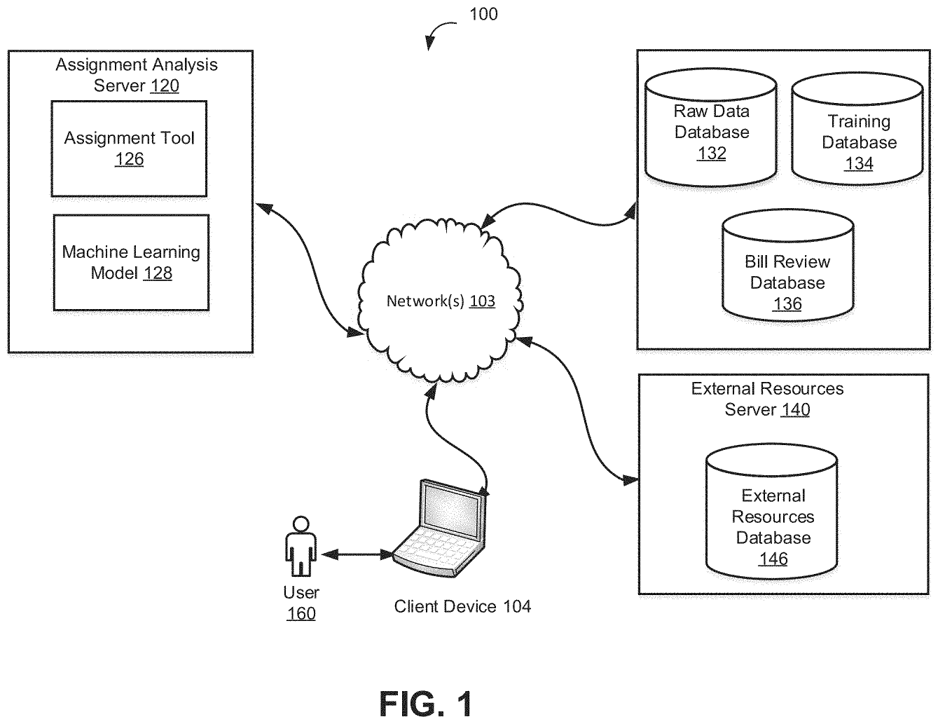

FIG. 1 illustrates an review and assignment system 100 according to some embodiments of the disclosed technology. In some embodiments, system 100 may include an assignment analysis server 120, a one or more external resources server(s) 140, a network 103, a one or more user computing device(s) 104 (e.g., an audit computing device, an insurance computing device, and so on) associated with one or more users 160 (e.g., an auditor, an insurance user). Additionally, system 100 may include other network devices such as one or more routers and/or switches.

In some embodiments, user computing device(s) 104 may include a variety of electronic computing devices, for example, a smartphone, a tablet, a laptop, a display, a mobile phone, a computer wearable device, such as smart glasses, or any other head mounted display device, or a combination of any two or more of these data processing devices, and/or other devices. In some embodiments, user computing device(s) 104 may be used by auditors and/or insurance users to interface with the assignment analysis computing device for the management and assignment of electronic bills for processing.

### Assignment Server

In some embodiments, assignment analysis server 120 may include a processor, a memory, and network communication capabilities. In some embodiments, assignment analysis server 120 may be a hardware server. In some implementations, assignment analysis server 120 may be provided in a virtualized environment, e.g., assignment analysis server 120 may be a virtual machine that is executed on a hardware server that may include one or more other virtual machines. Additionally, in one or more embodiments of this technology, virtual machine(s) running on assignment analysis server 120 may be managed or supervised by a hypervisor. Assignment analysis server 120 may be communicatively coupled to network 103.

In some embodiments, system 100 may employ one or more machine learning model 128, which may execute on assignment analysis server 120. For example, the memory of assignment analysis server 120 may include a neural network model 128 which may be configured to obtain raw data comprising bill auditor productivity data, bill characteristic data, and/or auditor workload data. The neural network model 128 may retrieve one or more stored scenarios of work assignments or formats based on the obtained raw data or one or more other policies, rules or procedures and use one or more data preprocessing modules to, process the raw data for consistency with or without one or more of the stored scenarios. Further, neural network model 128 may split the processed data into a training set of data, tune one or more parameters relating to making assignments using the training set of data. Finally, neural network model 128 may then train the neural network model 128 to comprise one or more trained models or other machine learning assignment algorithms for managing automated real time assignment of electronic bills, as described further in detail below. In other embodiments, the processing of the data may be executed separately from the training and/or other types of data may be used and/or other parameters may be tuned by train neural network model 128.

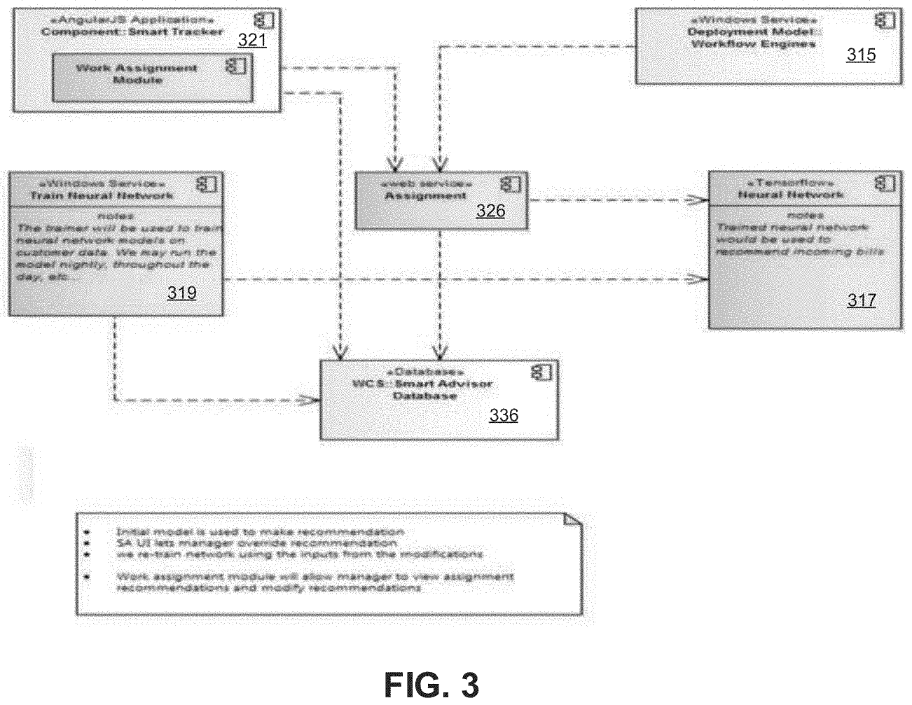

In some embodiments, the memory of assignment analysis server 120 may store application(s) that can include executable instructions that, when executed by assignment analysis server 120, cause assignment analysis server 120 to perform actions or other operations as described and illustrated below with reference to FIGS. 3-5. For example, assignment analysis server 120 may include an assignment tool 126 configured to utilize the trained neural network module 128 comprising one or more trained models or other machine learning assignment algorithms and the other split portion of the bill auditor productivity data, bill characteristic data, and auditor workload data to make automated real time assignments of electronic bills to auditor identification data.

In some embodiments, system 100 may include a raw data database 132, a training database, a bill review database 136, and/or other similar databases.

The raw data database 132 may store the electronic bills which need to be managed and assigned, although other types of data may be stored, such as current bill auditor productivity data, bill characteristic data, and auditor workload data. The training database 134 may store training data of past bill auditor productivity data, bill characteristic data, and auditor workload data used by the train neural network module to train the trained neural network module. The bill review database 136, such as a SmartAdvisor database, may include one or more database, which may store association data related to the current real time assignments of electronic bills to auditor identification data.

In some embodiments, assignment tool 126 may utilize data stored in raw data database 132, training database 134, bill review database 136, and/or other databases, as will be described in detail below. For example, assignment tool 126 may access raw data database 132, training database 134, bill review database 136 over a network 130 such as the Internet, via direct links, and the like.

In some embodiments, assignment tool 126 may comprise a work assignment module and a web service assignment module. The work assignment module may comprises an interface and instructions that enable an administrator to view and adjust the automated real time assignments of electronic bills to auditor identification data.

The web service assignment module may comprise application programing interface (API) configured to connect the work assignment module (the requester of the bills assignment) to the neural network model 128. In some embodiments, the web service assignment module may be configured to function as a middleman between the requester of the bills assignment and the neural network 128. For example, the web service assignment module may take bill and auditor data from the work assignment module and pass that data on to the neural network 128. After the neural network 128 has processed the data and determined the best assignment, the work assignment module may transmit the determination back to the requester of the bills assignment.

In some embodiments, assignment tool 126 may be implemented as one or more software packages executing on one or more assignment analysis server 120 computers, respectively. For example, a client application implemented on one or more user computing device(s) 104 as work assignment application.

In some embodiments, assignment tool 126 may be a server application, a server module of a client-server application, or a distributed application. In some embodiments, assignment tool 126 may be implemented using a combination of hardware and software. The application(s) can be implemented as modules, engines, or components of other application(s). Further, the application(s) can be implemented as operating system extensions, module, plugins, or the like.

Even further, the application(s) may be operative locally on the device or in a cloud-based computing environment. The application(s) can be executed within or as virtual machine(s) or virtual server(s) that may be managed in a cloud-based computing environment. Also, the application(s), and even the mapping or analysis computing devices themselves, may be located in virtual server(s) running in a cloud-based computing environment rather than being tied to one or more specific physical network computing devices. Also, the application(s) may be running in one or more virtual machines (VMs) executing on the mapping and analysis computing devices.

In some embodiments, assignment analysis server 120 may transmit and receive information to and from user computing device(s) 104, and/or other servers via network 103. For example, a communication interface of the assignment analysis server 120 may be configured to operatively couple and communicate between raw data database 132, training database 134, bill review database 136, user computing device 104, which are all coupled together by the communication network(s) 103.

In some embodiments, assignment analysis server 120 may be a standalone device or integrated with one or more other devices or apparatuses, such as one or more of the storage devices, for example. For example, assignment analysis server 120 may include or be hosted by one of the storage devices, and other arrangements are also possible.

### External Resource Server

In some embodiments, external resources server 140 may be configured to store raw medical bill data, historical data, and other such similar data. In some embodiments, external resources server 140 may include external resources database 146. In some embodiments, external resources servers 140 may be configured to communicate with additional disparate third-party services (e.g., bills review ending) to obtain data related to fee schedule reductions.

In some embodiments, external resources server 140 may include any type of computing device that can be used to interface with assignment analysis server 120 and/or assignment tool 126, raw data database 132, training databases 134, bill review database 136, and client computing device tool 104. For example, external resources server 140 may include a processor, a memory, and a communication interface, which are coupled together by a bus or other communication link, although other numbers and/or types of network devices could be used. In some embodiments, external resources server 140 may also include a database 146.

### System Architecture

In some embodiments, assignment analysis server 120 and or other components may be a single device. Alternatively, a plurality of devices may be used. In some embodiments, assignment analysis server 120 may not be limited to a particular configuration. Thus, in some embodiments, assignment server may contain a plurality of network devices that operate using a master/slave approach, whereby one of the network devices operate to manage and/or otherwise coordinate operations of the other network devices. Additionally, in some embodiments, assignment analysis server 120 may comprise different types of data at different locations.

In some embodiments, assignment server may operate as a plurality of network devices within a cluster architecture, a peer-to-peer architecture, virtual machines, or within a cloud architecture, for example. Thus, the technology disclosed herein is not to be construed as being limited to a single environment and other configurations and architectures are also envisaged.

Although the exemplary system 100 with user computing device(s) 104, assignment analysis server 120, external resources server 140, and network(s) 103 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment, such as user computing device(s) 104, assignment analysis server 120, and external resources server 140 may be configured to operate as virtual instances on the same physical machine. In other words, one or more of user computing device(s) 104, assignment analysis server 120, external resources servers 140 may operate on the same physical device rather than as separate devices communicating through communication network(s).

In addition, two or more computing systems or devices can be substituted for any one of the systems or devices, in any example set forth herein. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including, by way of example, wireless networks, cellular networks, PDNs, the Internet, intranets, and combinations thereof.

In some embodiments, the assignment process 326 performed by assignment tool (e.g., assignment tool 126 on assignment analysis server 120 in FIG. 1) may be implemented using architecture illustrated in FIG. 3. In some embodiments, assignment process 326 may include a work assignment module 321, a workflow engine 315, a trained neural network 319, and a neural network 317. Additionally, assignment process 326 may be configured to use a shared dataset 336 (e.g., bill review database 136 in FIG. 1).

### Method

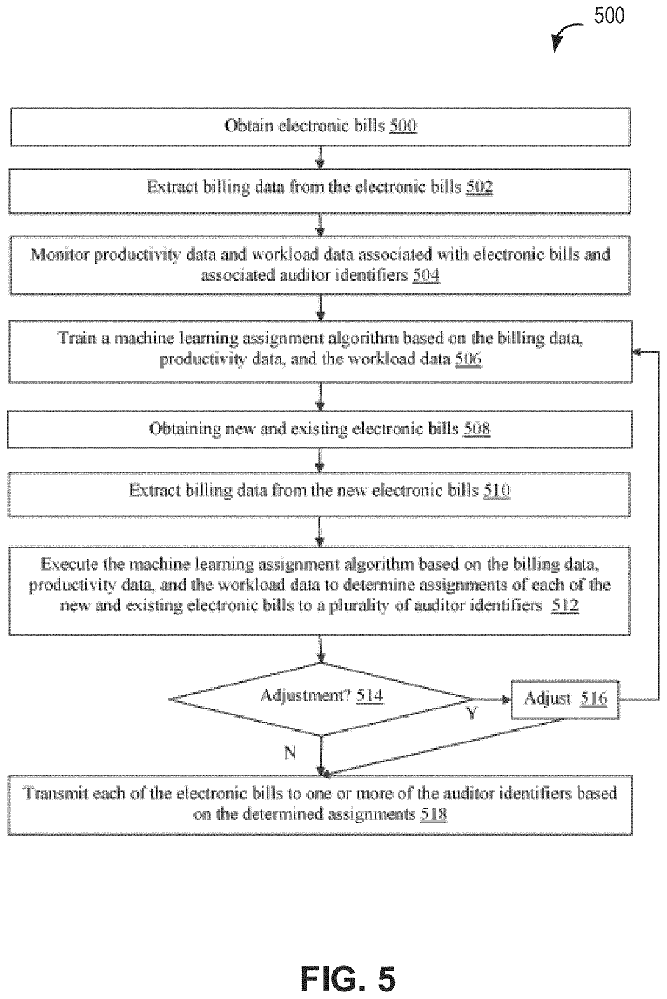

By virtue of automatically determining assignment, allows the system to automatically generate an assignment of an electronic bill to an auditor best suited for the bill review. For example, FIG. 5 illustrates a process 500 for determine assignment of an electronic bill according to some embodiments of the disclosed technology.

The process 500 may begin with in step 501 the obtaining data comprising raw electronic bills. In some embodiments, raw data may be a physical document (e.g., which may scanned by an OCR system and/or translated to electronic media by manual input or other mechanisms), or it may be an electronically submitted document. The raw data may be obtained from a plurality of sources (e.g., obtained from an external resources sever 140 illustrated in FIG. 1).

In some embodiments, a portion of the raw data obtained in steep 501 which may be used to train a machine learning assignment algorithm on determining assignments of each of the electronic bills to a plurality of auditor identifiers operating at the audit computing devices from the insurance computing devices (e.g., user computing device(s) 104 illustrated in FIG. 1), although this data may be obtained from other sources.

Method 500 may process the electronic bill data for consistency using one or more data preprocessing modules, although other types of data processing to facilitate the training may be executed. For example, method 500 may execute or send the electronic bills to a bills review engine where fee schedule reductions may get applied. In some embodiments, external resources sever 140, illustrated in FIG. 1, may include a bills review engine

The fee schedule reduction may depend on one or more characteristics associated with electronic bills including, for example, jurisdiction, type of bill, and a current Procedural Terminology (CPT) code. Once the fee schedule reductions are applied, the allowed amount is then populated and then this data may be used as part of the training data to build the algorithm as described in the example herein.

In step 502, method 500 may also extract and store characteristics from each of the electronic bills. For example, the characteristics may comprise a type of bill, jurisdiction, charges amount, bill age, type of injury, age of claim, and/or medical provider, although other types and/or numbers of characteristic may be extracted. In some embodiments, these characteristics associated with electronic bills may be obtained from other sources, such as from other bill review systems or claim systems, by way of example.

In step 504, method 500 may monitor and store productivity data and workload data associated with each of the auditor identifiers (i.e., uses) operating at the audit computing devices. For example, the productivity data may comprise metrics or other characteristics relating to with each of the auditor identifiers operating at the audit computing devices, such as data on an amount of time to work on each of a plurality of types of electronic bills and data on total work time in a given day or other time period, although other types and/or numbers of metrics may be obtained. Additionally, the workload data may comprise data on a quantity and one or more characteristics from each of the electronic bills currently assigned to each of the auditor identifiers operating at the audit computing devices, although other types of data may be obtained. Further, in other examples, the method may obtain the productivity data and/or the workload data from other sources.

In step 506, method 500 may train a neural network module (e.g., neural network module 128 illustrated in FIG. 1) to comprise one or more trained models or other machine learning assignment algorithms for managing automated real time assignment of electronic bill based on at least a portion of the obtained electronic bills, productivity data, one or more characteristics of the bills, although other types of data or other information may be used to train the machine learning assignment algorithm. Other artificial intelligence techniques may be used instead of, or in addition to, using a machine learning model. By virtue of utilizing a machine learning approach enhances the automated real time assignment of electronic bill process described herein. In particular, by using machine learning model, allows the system to assign a bill that is likely best suited to perform the review.

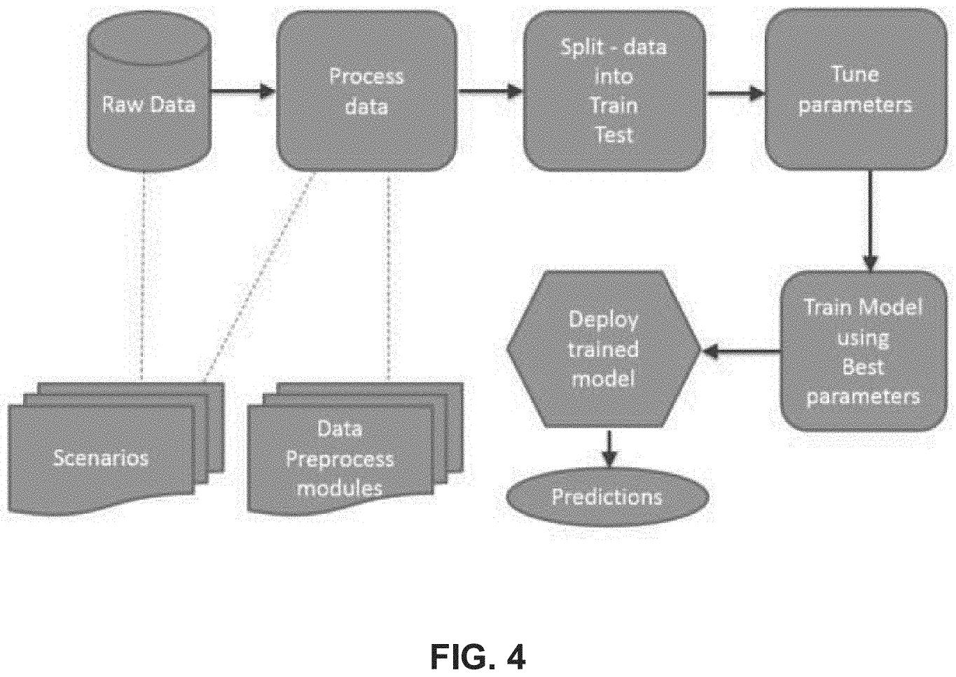

For example, as illustrated in FIG. 4, a machine learning training model, including data acquisition, processing, cleaning, and other steps of the machine learning training and execution process may be used. The machine learning model may be any machine learning mode, algorithm, or an Artificial Intelligence (AI) technique, capable of the functions described herein. Training the machine learning model may include supervised learning, unsupervised learning, or combinations thereof.

In some embodiments, one or more data categories may be used during the training state. For example, bill auditors productivity metrics specifying productivity metrics across the team in a bill review system including the amount of time it takes each auditor to work on bills and the auditor's total work time on a given day and/or other data elements, for the previously assigned bills may be applied as inputs to the machine learning model. Similarly, bill characteristics including a type of bill, jurisdiction, charged amount, bill age, type of injury, age of claim, medical provider, etc., obtained from bill review systems, claim systems, PBMs, and utilization review systems may be used. Finally, current auditor's workload including the quantity and characteristic of bills currently assigned to each auditor in a team within a bill review system may be used. During the training stage, process in 506 may include the machine learning model storing the values related to the decisions made during the training stage in a training database 134, as illustrated in FIG. 1.

In step 508, method 500 may obtain data related to unaudited new and existing electronic bills, such as electronic bills that may be currently assigned to one or more of the auditor identifiers operating at the audit computing devices from the audit computing devices and the insurance computing devices, although this data may be obtained from other sources. This data may be new data or may comprise be another portion of the data obtained in step 501 which was split and not utilized for training the machine learning assignment algorithm.

In step 510, method 500 may extract and store characteristics from each of the new electronic bills. For example, these characteristics may comprise a type of bill, jurisdiction, charged amount, bill age, type of injury, age of claim, and/or medical provider, although other types and/or numbers of characteristic may be extracted. In some embodiments, these characteristics in each of the electronic bills may be obtained from other sources, such as from other bill review systems or claim systems, by way of example.

In step 512, method 500 may execute the trained neural network module comprising one or more trained models or other machine learning assignment algorithms for managing automated real time assignment of electronic bill in real time based on the billing data, productivity data, and the workload data to determine assignments of each of the new and existing electronic bills to the auditor identifiers at the audit computing devices.

In step 514, method 500 may provide an interface to one or more administrators at for example one of the audit computing devices to review the assignments and determine if an adjustment is needed on one or more determined assignments. If, in step 514, the method determines that an adjustment is needed, then the “Yes” branch is taken to step 516.

In step 516, method 500 may enter and record the adjustment to one or more of the assignments and then may return to step 506 where the adjustment may be used in ongoing training of the machine learning assignment algorithm and to step 518.

If, back in step 514, method 500 determines that an adjustment is not needed and/or no adjustment has been entered, then the “No” branch is taken to step 516

In step 518, method 500 may transmit each of the new and existing electronic bills to one or more of the auditor identifiers at the audit computing devices based on the determined assignments. Accordingly, the examples of the claimed technology are able to in real time to optimize the assignments of electronic bills or other types of work. Additionally, during a work time period the assignment analysis computing device may reevaluate the existing electronic bills and in real time adjust determined assignments transparently to one or more of the auditor identifiers at the audit computing devices to facilitate processing of the electronic bills.

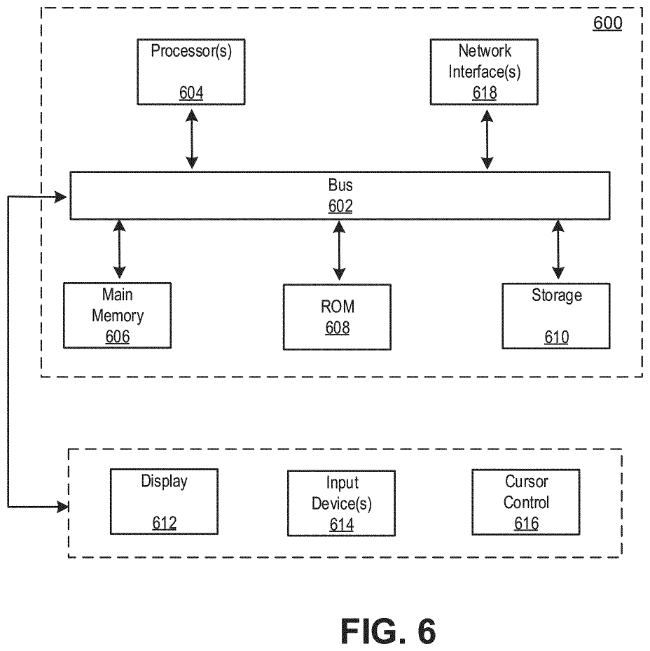

### Computer System

Where circuits are implemented in whole or in part using software, in one embodiment, these software elements can be implemented to operate with a computing or processing system capable of carrying out the functionality described with respect thereto. One such example computing system is shown in FIG. 6. Various embodiments are described in terms of this example-computing system 600. After reading this description, it will become apparent to a person skilled in the relevant art how to implement the technology using other computing systems or architectures.

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors and/or specialized graphical processors.

The computer system 600 also includes a main memory 605, such as a random access memory (RAM), cache and/or other dynamic storage devices, coupled to bus 602 for storing information and instructions to be executed by processor 604. Main memory 605 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such a SSD, magnetic disk, optical disk, or USB thumb drive (Flash drive), etc., is provided and coupled to bus 602 for storing information and instructions.

The computer system 600 may be coupled via bus 602 to a display 612, such as a transparent heads-up display (HUD) or an optical head-mounted display (OHMD), for displaying information to a computer user. An input device 614, including a microphone, is coupled to bus 602 for communicating information and command selections to processor 604. An output device 616, including a speaker, is coupled to bus 602 for communicating instructions and messages to processor 604.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, boy Java, Java, C or C++. A software component may be compiled and linked into an executable program, installed in a dynamic link library, or may be written in an interpreted programming language such as, for example, BASIC, Perl, or Python. Components may also be written in a database language such as SQL and/or handled via a database object such as a trigger or a constraint. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 605. Such instructions may be read into main memory 605 from another storage medium, such as storage device 610. Execution of the sequences of instructions contained in main memory 605 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 605. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire, and fiber optics, including the wires that comprise bus 602. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
a hardware processor; and
a non-transitory machine-readable storage medium encoded with instructions executable by the hardware processor to perform a method comprising:
executing a machine learning assignment algorithm that determines assignments of each of a plurality of new and existing electronic bills to a plurality of auditor identifiers based on:
current productivity data comprising two or more metrics associated with each of plurality of auditor identifiers;
current billing data comprising one or more characteristics of each of the new and existing electronic bills; and
current workload data comprising a quantity and one or more of the characteristics of the existing electronic bills associated with each of the auditor identifiers; and
transmitting, by the computing device, the determined assignments of each of the electronic bills to one or more of the auditor identifiers.

2. The system of claim 1, the method further comprising:
training, by the computing device, the machine learning assignment algorithm based on at least:
historic productivity data comprising two or more metrics associated with each of the auditor identifiers;
historic billing data comprising one or more characteristics of prior unaudited electronic claims; and
historic monitored workload data comprising a quantity and one or more characteristics of the prior electronic bills associated with the auditor identifiers.

3. The system of claim 2 further comprising receiving, by the computing device, an adjustment of at least one of the determined assignments of the electronic claims, wherein the training the machine learning assignment algorithm is further based on the received adjustment.

4. The system of claim 1 further comprising monitoring, by the computing device, to obtain at least a portion of the current productivity data and the current workload data associated with the auditor identifiers.

5. The system of claim 1 further comprising extracting, by the computing device, the one or more characteristics of each of the new and existing electronic bills to obtain the current billing data.

6. The system of claim 1 wherein the two or more characteristics of the current productivity data further comprises amount of time data required to work on each of a plurality of types of electronic bills and overall work time data associated with the auditor identifiers.

7. The system of claim 1 wherein the one or more characteristics of each of the new and existing electronic bills comprise one of a plurality of types, one of a plurality of jurisdictions, charge amounts, bill age, one of a plurality of types of injuries, or one of a plurality of medical provider identifiers.

8. A method implemented by a server computer, the method comprising:
executing a machine learning assignment algorithm that determines assignments of each of a plurality of new and existing electronic bills to a plurality of auditor identifiers based on:
current productivity data comprising two or more metrics associated with each of plurality of auditor identifiers;
current billing data comprising one or more characteristics of each of the new and existing electronic bills; and
current workload data comprising a quantity and one or more of the characteristics of the existing electronic bills associated with each of the auditor identifiers; and
transmitting, by the computing device, the determined assignments of each of the electronic bills to one or more of the auditor identifiers.

9. The method of claim 8, the method further comprising:
training machine learning assignment algorithm based on at least:
historic productivity data comprising two or more metrics associated with each of the auditor identifiers;
historic billing data comprising one or more characteristics of prior unaudited electronic claims; and
historic monitored workload data comprising a quantity and one or more characteristics of the prior electronic bills associated with the auditor identifiers.

10. The method of claim 9, the method further comprising:
receiving an adjustment of at least one of the determined assignments of the electronic claims, wherein the training the machine learning assignment algorithm is further based on the received adjustment.

11. The method of claim 9, the method further comprising:
monitoring to obtain at least a portion of the current productivity data and the current workload data associated with the auditor identifiers.

12. The method of claim 9, the method further comprising:
extracting the one or more characteristics of each of the new and existing electronic bills to obtain the current billing data.

13. The method of claim 9, wherein the two or more characteristics of the current productivity data further comprises amount of time data required to work on each of a plurality of types of electronic bills and overall work time data associated with the auditor identifiers.

14. The method of claim 9, wherein the one or more characteristics of each of the new and existing electronic bills comprise one of a plurality of types, one of a plurality of jurisdictions, charge amounts, bill age, one of a plurality of types of injuries, or one of a plurality of medical provider identifiers.

15. A non-transitory machine-readable storage medium encoded with instructions executable by a hardware processor of a computing component, the machine-readable storage medium comprising instructions to cause the hardware processor to perform a method comprising:
executing a machine learning assignment algorithm that determines assignments of each of a plurality of new and existing electronic bills to a plurality of auditor identifiers based on:
current productivity data comprising two or more metrics associated with each of plurality of auditor identifiers;
current billing data comprising one or more characteristics of each of the new and existing electronic bills; and
current workload data comprising a quantity and one or more of the characteristics of the existing electronic bills associated with each of the auditor identifiers; and
transmitting, by the computing device, the determined assignments of each of the electronic bills to one or more of the auditor identifiers.

16. The non-transitory machine-readable storage medium of claim 15, the method further comprising:
training machine learning assignment algorithm based on at least:
historic productivity data comprising two or more metrics associated with each of the auditor identifiers;
historic billing data comprising one or more characteristics of prior unaudited electronic claims; and
historic monitored workload data comprising a quantity and one or more characteristics of the prior electronic bills associated with the auditor identifiers.

17. The non-transitory machine-readable storage medium of claim 16, the method further comprising:
receiving an adjustment of at least one of the determined assignments of the electronic claims, wherein the training the machine learning assignment algorithm is further based on the received adjustment.

18. The non-transitory machine-readable storage medium of claim 16, the method further comprising:
monitoring to obtain at least a portion of the current productivity data and the current workload data associated with the auditor identifiers.

19. The non-transitory machine-readable storage medium of claim 16, the method further comprising:
extracting the one or more characteristics of each of the new and existing electronic bills to obtain the current billing data.

20. The non-transitory machine-readable storage medium of claim 16, wherein the two or more characteristics of the current productivity data further comprises amount of time data required to work on each of a plurality of types of electronic bills and overall work time data associated with the auditor identifiers.

21. The non-transitory machine-readable storage medium of claim 16, wherein the one or more characteristics of each of the new and existing electronic bills comprise one of a plurality of types, one of a plurality of jurisdictions, charge amounts, bill age, one of a plurality of types of injuries, or one of a plurality of medical provider identifiers.
